(19) United States
(12) Patent Application Publication
(10) Pub. No.: US 2008/0175108 A1
(43) Pub. Date: Jul. 24, 2008

(54) OPTICAL INFORMATION STORAGE MEDIUM SYSTEM AND METHOD OF GENERATING TRACKING ERROR SIGNAL

(75) Inventors: Kyongtae Park, Suwon-si (KR); Tae-kyung Kim, Seoul (KR); Jae-cheol Bae, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/966,073

(22) Filed: Dec. 28, 2007

(30) Foreign Application Priority Data
Jan. 19, 2007 (KR) 2007-6291

(51) Int. Cl. G11B 7/00

(52) U.S. Cl. 369/44.23

(57) ABSTRACT

An optical information storage medium system includes an optical pick-up to detect a main push-pull signal and a sub-push pull signal, and a signal operating unit including first and second operating parts to respectively generate a main push-pull signal and a sub-push-pull signal, a noise removing unit to electrically filter the sub-push-pull signal to remove noise caused by light reflected by layers other than a target layer for recording and/or reproducing, and a subtractor to generate a tracking error signal by subtraction of the main push-pull signal and the sub-push-pull signal which is filtered by the noise removing part.

### CROSS-REFERENCE TO RELATED APPLICATIONS

This application claims the benefit of Korean Application No. 2007-6291, filed Jan. 19, 2007 in the Korean Intellectual Property Office, the disclosure of which is incorporated herein by reference.

### BACKGROUND OF THE INVENTION

1. Field of the Invention

Aspects of the present invention relate to an optical information storage medium system and a method of generating a tracking error signal, and more particularly, to an optical information storage medium system including an optical pick-up which enables a multi-layered optical information storage medium to generate a stable tracking error signal by removing an interference signal generated from other non targeted layers when the optical information storage medium is recorded or reproduced, and a method for generating the stable tracking error signal.

2. Description of the Related Art

A multi-layered optical disc is used to increase the storage capacity of an optical information storage medium, that is, an optical disc. One of the drawbacks caused when a multi-layered optical disc is used is the generation of noise in a signal received by a light receiving part due to light reflected from a non-targeted layer.

The generation of the noise component is troublesome for optical information storage medium systems which generate servo signals using a signal output from the light receiving part. A method generally used to remove the noise uses an additional optical element disposed in a path of light that proceeds towards the light receiving part so that light reflected from layers other than a target layer used to record and/or reproduce data cannot reach the light receiving part.

However, in the method described above, not only does the additional optical element block light reflected by the non-targeted layers, but the additional optical element also blocks part of the light reflected from the target layer. Thus, this conventional method reduces optical efficiency of the optical information storage medium system.

### SUMMARY OF THE INVENTION

To solve the above and/or other problems, aspects of the present invention provide an optical information storage medium system in which stable tracking can be generated without reducing optical efficiency, since the light reflected by the target layer is not blocked even when light is reflected by a non targeted layer when data is recorded and/or reproduced to and/or from an optical information storage medium, and a method of generating a tracking error signal.

According to an aspect of the present invention, an optical information storage medium system includes an optical pick-up to irradiate light to an optical information storage medium and detect the light reflected by the optical information storage medium, including a diffraction device to divide the light emitted from the light source into a main light beam which is transmitted straight through the diffraction device and a first diffracted light beam, and to radiate the main light beam and the first diffracted light beam to the optical information storage medium, and a photo detector, including a main photo detector to detect the main light beam reflected by the optical information storage medium, and a first sub-photo detector to detect the first diffracted light beam reflected by the optical information storage medium, and a signal operating part to generate a tracking error signal, including first and second operating parts to respectively generate a main push-pull signal and a first sub-push-pull signal from the main light beam and the first diffracted light beam detected by the main photo detector and the first sub-photo detector, a noise removing unit to electrically filter the first sub-push-pull signal to remove noise due to part of the light reflected by a layer other than a target layer for recording and/or reproducing data to and/or from the optical information storage medium, and a subtractor to generate the tracking error signal by subtraction using the main push-pull signal and the first sub-push-pull signal.

According to an aspect of the present invention, the second operating part generates the first sub-push-pull signal by removing phase change components caused by track transverse of the first diffracted light beam.

According to an aspect of the present invention, the optical information storage medium system includes a second sub-photo detector to detect a second diffracted light beam reflected by the optical information storage medium, wherein the first diffracted light beam is a +1st-order diffracted light and the second diffracted light beam is a −1st-order diffracted light beam, and the second operating part respectively generates the first sub-push-pull signal and a second sub-push-pull signal from the +1 st-order light diffracted beam detected by the first sub-photo detector and the −1st-order diffracted light beam detected by the second sub-photo detector.

According to an aspect of the present invention, the second operating part generates the first sub-push-pull signal and the second sub-push-pull signal by removing phase change components caused by track transverse of the +1st-order diffracted light beam and the −1st-order diffracted light beam.

According to an aspect of the present invention, the second operating part includes a first subtractor to generate the first sub-push-pull signal based on the +1 st-order diffracted light beam detected by the first sub-photo detector; a second subtractor to generate the second sub-push-pull signal based on the −1st-order diffracted light beam detected by the second sub-photo detector, a first low frequency band-pass filter to remove the phase change component caused by the track transverse of the +1st-order diffracted light beam from the first sub-push-pull signal, a second low frequency band-pass filter to remove the phase change component caused by the track transverse of the −1st-order diffracted light beam from the second sub-push-pull signal, and an adder to add the first sub-push signal and the second sub-push-pull signal after the first sub-push-pull signal and the second sub-push signal have respectively passed through the first low frequency band-pass filter and the second low frequency band-pass filter.

According to an aspect of the present invention, the optical information storage medium system further includes a gain adjuster to adjust a gain of at least one of the main push-pull signal or the first sub-push-pull signal.

According to an aspect of the present invention, the gain adjuster matches DC offset variations of the main push-pull signal and the sub-push-pull signal.

According to an aspect of the present invention, the gain adjuster adjusts a DC level of the sub-push-pull signal obtained from the second operating part to match the DC offset variation of the main push-pull signal.

According to an aspect of the present invention, the noise removing unit has a bandwidth of lower than an RF signal frequency of the optical information storage medium and higher than an eccentric frequency of the optical information storage medium.

According to an aspect of the present invention, the noise removing unit has a bandwidth of less than 50 Hz.

According to another aspect of the present invention, a method of generating a tracking error signal includes irradiating light emitted from a light source to an optical information storage medium by dividing the light into a main light beam which is transmitted in a straight direction and a diffracted light beam, generating a main push-pull signal and a sub-push-pull signal by respectively detecting the main light beam reflected by the optical information storage medium and the diffracted light beam reflected by the optical information storage medium, electrically filtering noise due to the light reflected by a layer other than a target layer for recording and/or reproducing data from the sub-push-pull signal, and generating a tracking error signal by subtracting the sub-push-pull signal from the main push-pull signal.

According to another aspect of the present invention, the generating of the sub-push-pull signal further includes removing phase change components caused by track transverse of the diffracted light beam.

According to another aspect of the present invention, the method further includes adjusting a gain of at least one of the main push-pull signal or the sub-push-pull signal.

According to another aspect of the present invention, the adjusting of the gain is performed to match a DC offset variation of the main push-pull signal with a DC offset variation of the sub-push-pull signal.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more apparent and more readily appreciated from the following description of the embodiments, taken in conjunction with the accompanying drawings of which:

FIG. 1 is a schematic drawing showing the main configuration of an optical information storage medium system according to an embodiment of the present invention;

FIG. 2 is a schematic drawing of an optical configuration of optical pick-up suitable for use in the optical information storage medium system shown in FIG. 1, according to an embodiment of the present invention;

FIG. 3 shows electrical signals at each terminal of the system of FIG. 1 when a DC offset change is generated in a push-pull signal due to an objective lens shift or other disturbance; and

FIG. 4 is a schematic drawing showing an overall configuration of an optical information storage medium system according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A differential push-pull (DPP) method to compensate for an offset of a push-pull signal which is generated during reproducing of data from an eccentric optical information storage medium is generally employed as a tracking method of a recordable optical information storage medium. An optical information storage medium system according to aspects of the present invention has a configuration based on the DPP method. The configuration generates a uniform and stable tracking signal when a multi-layered optical information storage medium is recorded or reproduced by removing the effects of noise light reflected by a non-targeted layer of the storage medium using an electric filtering method even when an objective lens shift or other disruption causes a DC offset.

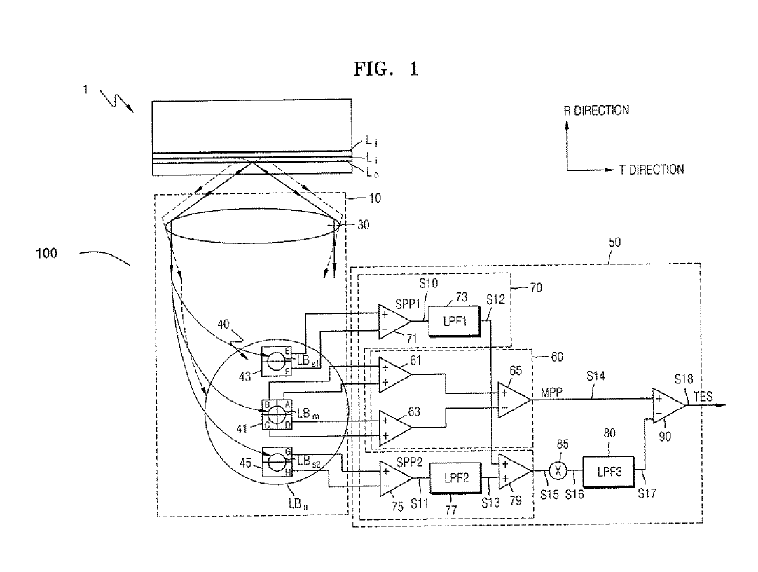

FIG. 1 is a schematic drawing showing the main configuration of an optical information storage medium system 100 according to an embodiment of the present invention. Referring to FIG. 1, the optical information storage medium system 100 includes an optical pick-up 10 to irradiate light to an optical information storage medium 1, such as a DVD, a High-Density DVD (HD-DVD), or a Blu-ray DVD (BD), and detect light, i.e., a light beam, reflected by the optical information storage medium 1, and a signal operating unit 50 to detect a tracking error signal. Hereinafter, the term light may be used interchangeably with the term light beam.

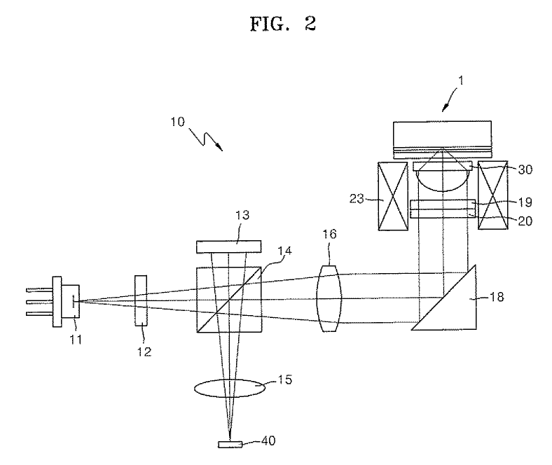

FIG. 2 is a schematic drawing of an example of an optical configuration of the optical pick-up 10 used with the optical information storage medium system 100 shown in FIG. 1, according to an embodiment of the present invention. Referring to FIG. 2, the optical pick-up 10 includes a diffraction device 12 to allow a main light beam and at least one diffracted light beam to be irradiated to the optical information storage medium 1 by dividing light emitted from a light source 11 into the main light beam and the at least one diffracted light beam. The optical pick-up 10 further includes a photo detector 40 having a main photo detector 41 and sub-photo detectors 43 and 45 which detect the main light beam and the at least one diffracted light beam reflected by the optical information storage medium 1.

The diffraction device 12 is configured to divide the light from the light source 11 into a 0 order diffracted light beam (a main light beam) which passes straight through, a +1 order diffracted light beam (also known as a first diffracted light beam), and a −1st-order diffracted light beam (also known as a second diffracted light beam). The diffracted light beam may be a +1st-order diffracted light beam and/or a −1st-order diffracted light beam. It is understood that the diffraction device 12 may divide the light from the light source 11 into more than a +1st-order diffracted light beam and a −1st-order diffracted light beam, such as, for example, a +2nd-order diffracted light beam and a −2nd-order diffracted light beam.

The photo detector 40 is formed to detect the main light beam and the two sub light beams (diffracted light beams). The main photo detector 41 of the photo detector 40 detects the main light beam irradiated to the optical information storage medium 1 and reflected by the optical information storage medium 1. The first and second sub-photo detectors 43 and 45 of the photo detector 40 detect the diffracted light beams irradiated to the optical information storage medium 1 and reflected by the optical information storage medium 1. According to an aspect of the present invention, the first and second sub-photo detectors 43 and 45 are configured so that the first sub-photo detector 43 detects the +1st order diffracted light beam and the second sub-photo detector 45 detects the −1st-order diffracted light beam so that the sub-photo detectors 43 and 45 respectively detect the diffracted light beams of the +1st-order and the −1st-order irradiated to and reflected by the optical information storage medium 1. Alternatively, one of the first and second sub-photo detectors 43 and 45 can be removed so that only one of the diffracted light beams, for example, the +1st-order or the −1st-order, is detected. Moreover, additional sub-photo detectors may be added to detect higher order diffracted light beams, such as +2nd-order and −2nd order diffracted light beams.

The main photo detector 41 is bisected into a direction (the R direction indicated by the arrow in FIG. 1) corresponding to a radial direction and a direction (the T direction indicated by the arrow in FIG. 1) corresponding to a tangential direction of the optical information storage medium 1 so that the main photo detector 41 detects a focus error signal in addition to detecting the main light beam. That is, the main photo detector 41 has at least a four-partitioned structure. In FIG. 1, the main photo detector 41 is divided into two parts in the R direction and two parts in the T direction. According to an aspect of the present invention, the main photo detector 41 has a structure in which four light receiving regions A, B, C, and D are included. Alternatively, the main photo detector 41 can have an eight-partitioned structure by dividing it into four parts in the R direction and two parts in the T direction. Furthermore, the main photo detector 41 can be divided into other numbers of parts in addition to four and eight, such as, for example, sixteen.

The first and second sub-photo detectors 43 and 45 are each divided into two parts in the R direction to enable the generation of sub-push-pull signals. Thus, the first sub-photo detector 43 has two light receiving regions E and F, and the second sub-photo detector 45 has two light receiving regions G and H. The signal operating unit 50 has an electrical circuit to generate a signal required for tracking a servo, that is, a tracking error signal, by using the light beams detected from the photo detector 40.

The signal operating unit 50 includes first and second operating parts 60 and 70 to respectively generate a main push-pull signal and a sub-push-pull signal from light beams detected by the main photo detector 41 and the sub-photo detectors 43 and 45, also known as the first sub-photo detector 43 and the second sub-photo detector 45, a noise removing unit 80 (LPF3) to remove noise caused by light reflected by layers other than a target recording and/or reproducing layer Lo, for example, a non-targeted layer Li adjacent to the target recording and/or reproducing layer L₀, by electrically filtering the sub-push-pull signal, and a subtractor 90 to generate a tracking error signal by performing a subtraction operation using the main push-pull signal and the sub-push-pull signal from which noise is removed by an electrical filtering operation. The signal operating part 50 further includes a gain adjuster 85 to adjust the gain of at least one of the main push-pull signal and the sub-push-pull signal.

The first operating part 60 includes two adders 61 and 63 and one subtractor 65. The first operation part 60 may be configured, for example, as depicted in FIG. 1 to detect the main push-pull signal from signals detected by the main photo detector 41. However, it is understood that the first operation part 60 may have a different configuration of logic circuits than those shown in FIG. 1 to achieve a similar result.

When the main photo detector 41 is divided into a quadrant structure to have four light receiving regions A, B, C, and D, the adder 61 adds signals detected from the two light receiving regions A and B located on one side of the main photo detector 41 in the R direction, and another adder 63 adds signals detected from the two light receiving regions C and D located on the other side of the main photo detector 41 in the R direction. The subtractor 65 generates a main push-pull signal MPP=(a+b)−(c+d) by subtraction, in which case an added signal c+d outputted from the adder 63 is subtracted from an added signal a+b outputted from the adder 61.

In the case that the light diffracted by the diffraction device 12 is the +1st-order light beam and the −1st-order light beam, and the sub-photo detectors 43 and 45 are configured so that the first sub photo detector 43 detects the +1st-order light beam and the second sub-photo detector 45 detects the −1st-order light beam, the second operating part 70 generates a sub-push-pull signal from signals detected by the first and second sub-photo detectors 43 and 45. In this case, the second operating part 70 is formed to generate a sub-push-pull signal from which phase change components caused by track transverse of the +1st-order light beam and the −1st-order light beam are removed.

More specifically, the second operating part 70 has a configuration in which a first subtractor 71 generates a first sub-push-pull signal (SPP1=e-f) with respect to the +1st-order light beam from the signals e and f detected from the two light receiving regions E and F of the first sub-photo detector 43, a second subtractor 75 generates a second sub-push-pull signal (SPP2=g-h) with respect to the −1st-order light beam from the signals g and h detected from the two light receiving regions G and H of the second sub-photo detector 45, first and second low frequency band-pass filters 73 (LPF1) and 77 (LPF2) to respectively filter the first and second sub-push-pull signals SPP1 and SPP2 to remove phase change components caused by the track transverse of the +1st-order light beam and the −1st-order light beam, and an adder 79 to generate a sub-push-pull signal SPP by adding the first and second sub-push-pull signals that have passed through the first and second low frequency band-pass filters 73 (LPF1) and 77 (LPF2). Alternatively, instead of the first and second low frequency band-pass filters 73 (LPF1) and 77 (LPF2), a low frequency band-pass filter can be disposed at an output terminal of the adder 79 to filter the phase change components caused by the track transverse of the 1st-order light beam (i.e., the +1st order light beam and/or the −1st-order light beam).

The second operating part 70 can be modified to have various configurations. For example, the second operating unit 70 is configured such that, after the added signal e+g from the detected signals e and g and the added signal f+h from the detected signals f and h are obtained, a sub-push-pull signal is obtained by subtracting one added signal from another added signal. In this case, the filtering operation to remove the phase change components caused by the track transverse of the +1st-order light beam and the −1st-order light beam can be respectively performed to each of the two added signals, or can be performed to the finally obtained sub-push-pull signal.

Also, one of the sub-photo detectors 43 and 45 can be formed to detect a sub-push-pull signal by receiving a single diffracted light beam, for example, the +1st-order light beam or the −1st-order light beam, instead of each of the sub-photo detectors 43 and 45 receiving both of the +1st-order light beam and the −1st-order light beam. In this case, the second operating part 70 includes one subtractor and one low frequency band-pass filter to remove the phase change components caused by the track transverse of the single diffracted light beam, and the operation of generating a tracking error signal is performed based on one diffracted light beam instead of two diffracted light beams.

The gain adjuster 85 is designed to match the variations of DC offset of the main push-pull signal and the sub-push-pull signal. The gain adjuster 85 is formed at an output end of the second operating part 70 to match a DC level of the sub-push-pull signal obtained from the second operating part 70 to the level of a DC offset variation of the main push-pull signal obtained from the first operating part 60 by adjusting the DC level of the sub-push-pull signal obtained from the second operating part 70.

Alternatively, the gain adjuster 85 can be formed on an output end of the first operating part 60 to match the DC level of the sub-push-pull signal obtained from the second operating part 70 with the DC offset variation of the main push-pull signal obtained from the first operating part 60 by adjusting the DC level of the main push-pull signal obtained from the first operating part 60. Furthermore, two gain adjusters 85 can be provided and each one can be respectively formed on each output end of the first operating part 60 and the second operating part 70 according to another aspect of the present invention.

The noise removing unit 80 receives the sub-push-pull signal transmitted from the second operating part 70. The noise removing unit 80 electrically filters noise which is included in the sub-push-pull signal and is caused by light reflected by layers other than the target recording and/or reproducing layer. The sub-push-pull signal input to the noise removing unit 80 may be a signal from which phase change components caused by the track transverse of a diffracted light irradiated to the optical information storage medium 1 are removed.

According to an aspect of the present invention, the noise removing unit 80 has a bandwidth which is lower than an RF signal frequency and higher than an eccentric frequency of the optical information storage medium 1. For example, the noise removing unit 80 may have a bandwidth of less than 50 Hz. The noise removing unit 80 can include a low frequency band-pass filter LPF3. However, it is understood that the noise removing unit 80 may have a bandwidth of 50 Hz or greater as well.

The RF signal frequency is approximately a few tens of MHz, and the eccentric frequency of the optical information storage medium 1 is approximately a few tens of Hz. When the optical information storage medium 1 is rotated at a 1× speed for recording and/or reproducing, the frequency of the tracking error signal TES can be, for example, approximately 6 kHz. The frequency of inter-layer interference noise caused by noise light reflected by layers other than the target recording and/or reproducing layer is greater than a tenth of a TES frequency and smaller than the TES frequency, and the bandwidth, that is, the inter-layer interference filtering frequency of the noise removing unit 80, is greater than the eccentric frequency and smaller than the inter-layer interference noise frequency.

The subtractor 90 generates a tracking error signal TES by subtracting the sub-push-pull signal, from which noise caused by light reflected by non-targeted layers is electrically filtered by the noise removing unit 80, from the main push-pull signal which is output from the first operating part 60.

In the optical information storage medium system 100 according to aspects of the present invention, the tracking error signal is generated according to the following method.

Light emitted from the light source 11 is irradiated to the optical information storage medium 1 by being divided into a main light beam and at least one diffracted light beam (i.e., a sub-light beam). The main photo detector 41 and the sub-photo detectors 43 and 45 detect the main light beam and the diffracted light beam which are reflected by the optical information storage medium 1, thereby enabling a generation of a main push-pull signal and a sub-push-pull signal. Next, noise caused by light reflected by non-targeted layers is electrically filtered from the detected sub-push-pull signal by the noise removing unit 80. Afterwards, the subtractor 90 generates a tracking error signal TES by subtracting the sub-push-pull signal, from which the noise is removed, from the main push-pull signal.

When the sub-push-pull signal is generated, phase change components caused by the track transverse of the diffracted light are removed. Also, the DC offset variation of the main push-pull signal is preferably matched with the DC offset variation of the sub-push-pull signal by adjusting the gain of at least one of the main push-pull signal and the sub-push-pull signal.

According to the optical information storage medium system 100 and the method of detecting the tracking error signal described above, the adverse effects of inter-layer interference are reduced by electrical filtering due for the following reasons.

When light is divided into a plurality of light beams using the diffraction device 12, in view of optical utilization efficiency, it is advantageous for a large quantity of the main light beam (0 order diffracted light beam) to proceed straight through. Thus, when light entering the diffraction device 12 is divided into three light beams, that is, 0th-order, +1st-order, and −1st-order diffracted light beams, the ratio of, for example, −1st-order light: 0th-order light: +1st-order light is approximately a ratio of 1:10:1. However, the ratio is not limited to being 1:10:1, for example, the quantity of 0th-order light may be bigger or smaller than 10 times the quantity of the +1st-order and the −1st-order.

As illustrated in FIG. 1, the main photo detector 41 and the first and second sub-photo detectors 43 and 45 detect not only the main light beam LBm and the sub-light beams LBs1 and LBs2 but also light (hereinafter, a noise light LBn) reflected by non-targeted layers other than the target recording and/or reproducing layer Lo. The noise light LBn is radiated on a wide region represented by the circle shown in FIG. 1 encompassing the main photo detector 41 and the first and second sub-photo detectors 43 and 45.

The noise light LBn reflected by the non-targeted layers enters the light receiving units when information is recorded or reproduced on or from the multi-layered optical information storage medium 1, and acts as a noise component. The frequency of the noise component is generally slower than a phase change frequency of the push-pull signal generated by a track transverse of light.

Since the quantity of the main light beam LBm is relatively greater than the quantities of the sub-light beams LBs1 and LBs2, the effect of the noise with respect to the main light beam LBn is small, and thus can be ignored. Therefore, the level of the main push-pull signal MPP is hardly affected by the noise.

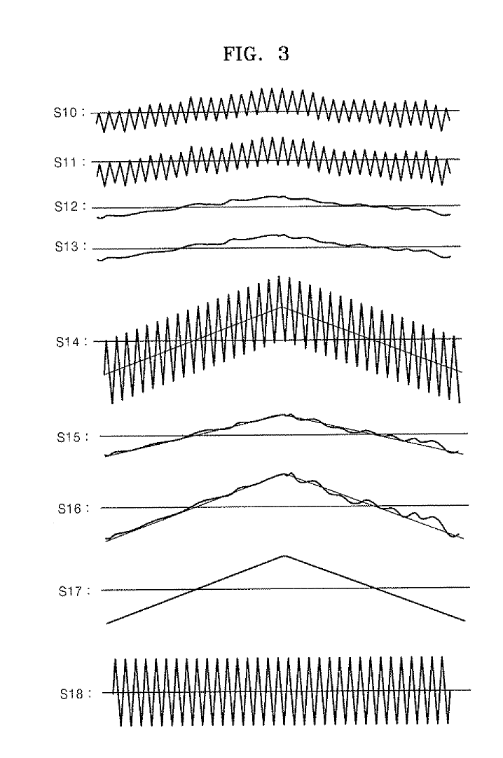

However, since the sub-light beams LBs1 and LBs2 are relatively small quantities of light, the effect of the noise light LBn on the sub-lights LBs1 and LBs2 is large. Accordingly, with respect to the first and second sub-push-pull signals SPP1 and SPP2, the vibration of the noise light LBn is entirely transferred as a vibration of the center level of the first and second sub-push-pull signals SPP1 and SPP2, as illustrated in the electrical signals shown in FIG. 3.

FIG. 3 shows electrical signals at various points of the system shown in FIG. 1 when a DC offset change is generated in a push-pull signal caused by a disturbance, such as an objective lens shift. In FIG. 3, signals S10 and S11 are respectively the first and second sub-push-pull signals SPP1 and SPP2 obtained at output ends of the first and second subtractors 71 and 75 of the second operating unit 70. As illustrated in FIG. 3, the center level of the first and second sub-push-pull signals SPP1 and SPP2 change due to the noise light LBn reflected by non-targeted layers when a track transverse phase is changed by the sub-light beams LBs1 and LBs2.

In FIG. 3, signals S12 and S13 are signals resulting from the removal of the phase change components from the first and second sub-push-pull signals SPP1 and SPP2 by passing the signals S10 and S11 through the first and second low frequency band-pass filters 73 and 77. When the first and second sub-push-pull signals SPP1 and SPP2 pass through the first and second low frequency band-pass filters 73 and 77, since the phase change components caused by the track transverse of the +1st-order light beam and the −1st-order light beam are removed, ideally, only the DC levels remain. However, as shown in signals S12 and S13, DC level vibrations remain in the filtered first and second sub-push-pull signals S12 and S13 due to the noise light LBn reflected by the non-targeted layers. The level vibration does not substantially affect recording and/or reproducing operations when a single layer optical information storage medium is used, but can substantially affect recording and/or reproducing operations when a multi-layered optical information storage medium 1 is used.

In FIG. 3, a signal S14 is a main push-pull signal obtained at an output end of the first operating part 60. As illustrated by the signal S14, the noise light LBn does not substantially affect the main light beam LBm. The signal S14 illustrates a push-pull phase change which accompanies a uniform DC offset variation.

Signal S15 shows an added result of the first and second sub-push-pull signals S12 and S13 from which the phase change components are removed. When signal S14 and signal S15 are compared, there is a level scale difference of the DC offset variation between the main push-pull signal and the sub-push-pull signal from which the phase change components caused by track transverse are removed. The level scale difference is corrected by a level scaling circuit, such as, for example, the gain adjuster 85.

Signal S16 in FIG. 3 is a signal resulting from scaling the sub-push-pull signal S15 to match the variation width of the DC level of the main push-pull signal S14 with the variation width of the DC level of the sub-push-pull signal S15 by passing the signal S15 through a level scaling circuit, such as, for example, the gain adjuster 85. As illustrated in FIG. 3, the level vibration caused by the noise light LBn still remains in the signal S16 after matching the variation width of the DC level of the sub-push-pull signal S15 to the DC level of the main push-pull signal S14.

Signal S17 in FIG. 3 illustrates a signal resulting from an operation of electrically removing the level vibration from the sub-push-pull-signal S15 after passing the sub-push-pull signal S15 through the noise removing unit 80. In the signal S17, the noise components are removed and, at the same time, the DC offset variation width of the signal S17 accurately corresponds to the DC offset variation width of the main push-pull signal (MPP) S14.

Accordingly, if signal S17 is subtracted from signal S14, signal S18 is obtained.

Signal S18 is the tracking error signal TES obtained from the optical information storage medium system 100 according to aspects of the present invention. When the method of generating a tracking error signal according to aspects of the present invention is applied to the optical information storage medium system 100, unlike a typical method of removing noise light using an optical device, noise components generated from a multi-layered optical information storage medium 1 are removed without a loss of light. At the same time, even though an objective lens shift or other component may cause a DC offset variation, the method of generating a tracking error signal according to aspects of the present invention enables the generation of a uniform and stable tracking error signal TES.

An example of an optical configuration of the optical pick-up 10 employed in the optical information storage medium system 100 according to aspects of the present invention will now be described with reference to FIG. 2. The optical pick-up 10 includes the diffraction device 12 and the photo detector 40. The optical pick-up 10 further includes an objective lens 30 to focus light emitted from the light source 11 on the optical information storage medium 1 as a light spot, and an optical path changer to change an optical path of incident light. In order to meet the demand for a highly efficient optical recording and/or reproducing system, the optical path changer includes a polarization-dependent optical path changer, for example, a polarization beam splitter 14 to change the propagation path of incident light according to polarization, and further includes a quarter wave plate 19 between the polarization beam splitter 14 and the objective lens 30 to change the polarization of incident light.

The optical pick-up 10 further includes a compensation device, for example, a liquid crystal device 20 to generate a phase difference for compensating a spherical aberration caused by a thickness difference of the optical information storage medium 1. Alternatively, the compensation device may be omitted from the optical pick-up 10, and in this case, the quarter wave plate 19 can be disposed at the front of the polarization beam splitter 14.

The optical pick-up 10 further includes a collimating lens 16 to collimate the diverging light emitted from the light source 11 so that collimated light enters the objective lens 30, an astigmatism lens 15 to generate astigmatism to detect a focus error signal using an astigmatism method, a reflection mirror 18 to alter a path of light, and an actuator 23 to drive the objective lens 30 during focusing or tracking operations.

The light source 11 emits light of a predetermined wavelength. The predetermined wavelength may be, for example, in a blue color wavelength region which meets the specifications of HD DVDs, and BDs, for example, light having a wavelength of 405 nm. Furthermore, the objective lens 30 may have, for example, a high numerical aperture that meets a BD standard, that is, a numerical aperture of approximately 0.85.

As described above, when the light source 11 emits light of a blue color wavelength region and the objective lens 30 has the numerical aperture of 0.85, the optical information storage medium system according to aspects of the present invention can record or reproduce a high density optical information storage medium 1, in particular, an optical information storage medium of a BD standard.

The wavelength of the light source 11 and the numerical aperture of the objective lens 30 can be modified in various ways. Also, the optical configuration of the optical pick-up 10 can be modified in various ways. For example, the light source 11 can be configured to emit light of a red color wavelength region suitable for DVDS, for example, a wavelength of 650 nm, and the objective lens 30 can have a numerical aperture suitable for DVDs, for example, a numerical aperture of 0.65, so that the optical pick-up 10 can record and/or reproduce data to and/or from a DVD, wherein each side of the DVD has a plurality of recording and/or reproducing layers.

Also, the optical pick-up 10 according to aspects of the present invention can include a light source module to emit light having a plurality of wavelengths, for example, light in a blue wavelength region suitable for the high density optical information storage medium 1 and light in a red wavelength region suitable for DVDs, and the objective lens 30 can be configured to achieve a plurality of numerical apertures suitable for BDs and DVDs. Alternatively, the optical pickup 10 can further include an additional member to adjust the effective numerical aperture of the objective lens 30, such as, for example, a diffractive optical element.

The optical pick-up 10 records and/or reproduces data to and/or from the high density optical information storage medium 1 using the optical configuration depicted in FIG. 2. Additionally, the optical pickup 10 can further include an additional optical configuration to record and/or reproduce DVDs and/or CDs.

The polarization-dependent optical path changer, for example, the polarization beam splitter 14, allows light emitted from the light source 11 to proceed towards the objective lens 30, and allows light reflected by the optical information storage medium 1 to proceed towards the photo detector 40. In FIG. 2, the polarization beam splitter 14 is depicted as an example of the polarization-dependent optical path changer which selectively transmits and reflects incident light according to polarization. Alternatively, a polarization hologram device (not shown) can be used as the polarization-dependent optical path changer to transmit a polarized light beam emitted from the light source 11 without diffraction and diffract other polarized light beams reflected by the optical information storage medium 1 into a +1st-order light beam or a −1st-order light beam. When the polarization hologram device is used as the polarization-dependent optical path changer, the light source 11 and the photo detector 40 are configured as an optical module.

As described above, when the optical pick-up 10 includes the polarization-dependent optical path changer, for example, the polarization beam splitter 14 and the quarter wave plate 19, one light beam of linearly polarized light, for example, a p polarized light beam entering the polarization light beam splitter 14 from the light source 11, passes through a mirror surface of the polarization beam splitter 14, is converted to one circularly polarized light beam while passing through the quarter wave plate 19, and proceeds towards the optical information storage medium 1. The one circularly polarized light beam is converted to another circularly polarized light beam when the one circularly polarized light beam is reflected by the optical information storage medium 1, and is converted to another linearly polarized light beam, for example, an s polarized light beam, while re-passing through the quarter wave plate 19. The other linearly polarized light is reflected by the mirror surface of the polarization light beam splitter 14 and proceeds towards the photo detector 40.

As another example, instead of the polarization-dependent optical path changer 14 as an optical path changer, the optical pick-up 10 can include a beam splitter to transmit and reflect incident light in a predetermined ratio or a hologram device (not shown) to transmit light emitted from the light source 11 without diffraction and diffract incident light reflected by the optical information storage medium 1 as a +1st-order light beam and a −1st-order light beam. When the hologram device is used as the optical path changer, the light source 11 and the photo detector 40 are configured as an optical module.

When considering that p or s polarized light is generally emitted from a semiconductor laser that is used as the light source 11, the optical pick-up 10 according to an aspect of the present invention has an optical configuration in which a non-polarization-dependent optical path changer, such as the hologram device and the quarter wave plate 19, are used instead of the polarization-dependent optical path changer.

During a recording and/or reproducing operation to record and/or reproduce data to and/or from the multi-layered optical information storage medium 1 having a plurality of recording layers on each side, when a recording layer has a thickness, as measured from a light incident surface of the optical information storage medium 1 to the recording layer, which differs from a designed value of the objective lens 30, and data is recorded and/or reproduced to and/or from the recording layer, a compensation device may be used to perform the compensation function of spherical aberration due to the thickness difference.

According to an aspect of the present invention, the compensation device is the liquid crystal device 20. Since liquid crystals have polarization characteristics, the liquid crystal device 20 selectively generates a phase difference for a polarized incident light beam. The liquid crystal device 20 is operated by a power source (not shown), such as AC voltage.

When power is on, the liquid crystal device 20 compensates for spherical aberration caused by a thickness difference between the recording layer Lo on the optical information storage medium 1 and the recording layer which the optical pickup 10 is designed to be used with by changing a wavefront of incident light. To change a wavefront of incident light, the liquid crystal device 20 generates a phase difference with respect to a polarized light beam, for example, a p polarized light beam, that proceeds towards the optical information storage medium 1 from the light source 11. When power is off, the liquid crystal device 20 transmits incident light without generating a phase difference, that is, without changing a wavefront of the light, regardless of the polarization of the incident light.

According to an aspect of the present invention, the liquid crystal device 20 is disposed between the optical path changer and the quarter wave plate 19 so that the light incident on the liquid crystal device 20 transmitted from the light source 11 and the light incident on the liquid crystal device 20 after being reflected by the optical information storage medium 1 have different polarizations from each other.

Since the spherical aberration is caused by a thickness difference of the optical information storage medium 1, the spherical aberration caused by a thickness difference of the optical information storage medium 1 is corrected when the liquid crystal device 20 is configured and operated such that light that has passed through the liquid crystal device 20 has a phase distribution opposite to the phase distribution of the spherical aberration.

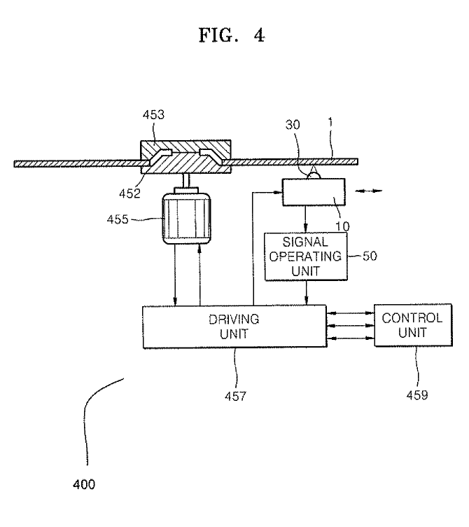

FIG. 4 is a schematic drawing showing an overall configuration of the optical information storage medium system 100 according to an embodiment of the present invention. The optical information storage medium system 100 includes a spindle motor 455 to rotate an optical information storage medium 1, an optical pick-up 10 installed to move in a radial direction of the optical information storage medium 1 during recording and/or reproducing operations, a signal operating part 50 to generate a tracking error signal TES using a signal detected by a photo detector 40 of the optical pick-up 10, a driving unit 457 to drive the spindle motor 455 and the optical pick-up 10, and a control unit 459 to adjust focusing and tracking servos of the optical pick-up 10. Additionally, the optical information storage medium system 100 includes a turn table 452, and a clamp 453 to hold the optical information storage medium 1 in place during recording and/or reproducing operations.

The optical pick-up 10 has an optical configuration as described above with reference to FIGS. 1 and 2. Light reflected by the optical information storage medium 1 is detected by the photo detector 40 of the optical pick-up 10, and a signal based on the detected light is input to the signal operating part 50. A tracking error signal TES is generated by the signal operating part 50, and is inputted to the adjusting unit 459 by the driving unit 457. The signal operating part 50 includes a circuit to generate the tracking error signal TES shown in FIG. 1. According to an aspect of the present invention, the signal operating part 50 further includes a circuit (not shown) to detect a focus error signal and an information reproduction signal (RF signal) using a detecting signal generated by the main photo detector 41. The driving unit 457 adjusts the rotation speed of the spindle motor 455, amplifies an inputted signal, and drives the optical pick-up 10. The control unit 459 transmits focus servo and tracking servo commands based on a signal inputted from the driving unit 457. The focus servo and tracking servo commands are transmitted to the driving unit to perform focusing and tracking operations of the optical pick-up 10.

The optical information storage medium system 100 according to aspects of the present invention reduces interference caused by light reflected by non-targeted layers, such as the layers Li and/or Lj in FIG. 1. In other words, the optical information storage medium system 100 according to aspects of the present invention removes interference signals generated between layers when recording and/or reproducing data to and/or from a multi-layered optical information storage medium 1, wherein the multi-layered optical information storage medium 1 has a plurality of recording layers. Thus, the optical information storage medium system 100 generates a uniform and stable tracking error signal even when the shifting of the objective lens 30 or some other disruption causes a DC offset variation.

As described above, according to aspects of the present invention, when recording and/or reproducing data to and/or from a multi-layered optical information storage medium system 100, light reflected by a target layer Lo is not blocked, thereby preventing the reduction of light efficiency. Furthermore the effect of noise light reflected by layers other than the target layer, that is, an interference signal generated by non-targeted layers, is electrically filtered, thereby generating a stable tracking error signal.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An optical information storage medium system, comprising:
an optical pick-up to irradiate light to an optical information storage medium and detect the light reflected by the optical information storage medium, comprising:
a diffraction device to divide the light emitted from a light source into a main light beam which is transmitted straight through the diffraction device and a first diffracted light beam, and to radiate the main light beam and the first diffracted light beam to the optical information storage medium, and
a photo detector, comprising:
a main photo detector to detect the main light beam reflected by the optical information storage medium; and
a first sub-photo detector to detect the first diffracted light beam reflected by the optical information storage medium; and
a signal operating part to generate a tracking error signal, comprising:
first and second operating parts to respectively generate a main push-pull signal and a first sub-push-pull signal from the main light beam and the first diffracted light beam detected by the main photo detector and the first sub-photo detector,
a noise removing unit to electrically filter the first sub-push-pull signal to remove noise due to part of the light reflected by a layer other than a target layer for recording and/or reproducing data to and/or from the optical information storage medium, and
a subtractor to generate the tracking error signal by subtraction using the main push-pull signal and the first sub-push-pull signal.

2. The optical information storage medium system of claim 1, wherein the second operating part generates the first sub-push-pull signal by removing phase change components caused by track transverse of the first diffracted light beam.

3. The optical information storage medium system of claim 1, further comprising:
a second sub-photo detector to detect a second diffracted light beam reflected by the optical information storage medium, wherein:
the first diffracted light beam comprises a +1st-order diffracted light beam and the second diffracted light beam comprises a −1st-order diffracted light beam, and
the second operating part respectively generates the first sub-push-pull signal and a second sub-push-pull signal from the +1st-order diffracted light beam detected by the first sub-photo detector and the −1st-order diffracted light beam detected by the second sub-photo detector.

4. The optical information storage medium system of claim 3, wherein the second operating part generates the first sub-push-pull signal and the second sub-push-pull signal by removing phase change components caused by track transverse of the +1st-order diffracted light beam and the −1st-order diffracted light beam.

5. The optical information storage medium system of claim 4, wherein the second operating part comprises:
a first subtractor to generate the first sub-push-pull signal based on the +1st-order diffracted light beam detected by the first sub-photo detector;
a second subtractor to generate the second sub-push-pull signal based on the −1st-order diffracted light beam detected by the second sub-photo detector;
a first low frequency band-pass filter to remove the phase change component caused by the track transverse of the +1st-order diffracted light from the first sub-push-pull signal;
a second low frequency band-pass filter to remove the phase change component caused by the track transverse of the −1st-order diffracted light beam from the second sub-push-pull signal; and
an adder to add the first sub-push-pull signal and the second sub-push-pull signal after the first sub-push-pull signal and the second sub-push-pull signal have respectively passed through the first low frequency band-pass filter and the second low frequency band-pass filter.

6. The optical information storage medium system of claim 1, further comprising a gain adjuster to adjust a gain of at least one of the main push-pull signal or the first sub-push-pull signal.

7. The optical information storage medium system of claim 6, wherein the gain adjuster matches DC offset variations of the main push-pull signal and the first sub-push-pull signal.

8. The optical information storage medium system of claim 7, wherein the gain adjuster adjusts a DC level of the first sub-push-pull signal obtained from the second operating part to match the DC offset variation of the main push-pull signal.

9. The optical information storage medium system of claim 8, wherein the noise removing unit has a bandwidth of lower than an RF signal frequency of the optical information storage medium and higher than an eccentric frequency of the optical information storage medium.

10. The optical information storage medium system of claim 9, wherein the noise removing unit has a bandwidth of less than 50 Hz.

11. The optical information storage medium system of claim 1, wherein the noise removing unit has a bandwidth of lower than an RF signal frequency of the optical information storage medium and higher than an eccentric frequency of the optical information storage medium.

12. The optical information storage medium system of claim 11, wherein the noise removing unit has a bandwidth of less than 50 Hz.

13. The optical information storage medium system of claim 1, wherein the main photo detector comprises four light receiving regions to detect a focus error signal in addition to detecting the main light beam.

14. The optical information storage medium system of claim 13, wherein the first operating part comprises:
a pair of adders, wherein one of the adders adds a portion of the main light beam detected in two of the four light receiving regions, and the other adder adds a portion of the main light beam detected in the other two of the four light receiving regions; and
a subtractor to generate the main push-pull signal by subtracting one of the added results from the other of the added results.

15. A method of generating a tracking error signal, comprising:
irradiating light emitted from a light source to an optical information storage medium by dividing the light into a main light beam which is transmitted in a straight direction and a diffracted light beam;
generating a main push-pull signal and a sub-push-pull signal by respectively detecting the main light beam reflected by the optical information storage medium and the diffracted light beam reflected by the optical information storage medium;
electrically filtering noise due to the light reflected by a layer other than a target layer for recording and/or reproducing data from the sub-push-pull signal; and
generating a tracking error signal by subtracting the sub-push-pull signal from the main push-pull signal.

16. The method of claim 15, wherein the generating of the sub-push-pull signal further comprises removing phase change components caused by track transverse of the diffracted light beam.

17. The method of claim 16, further comprising adjusting a gain of at least one of the main push-pull signal or the sub-push-pull signal.

18. The method of claim 17, wherein the adjusting of the gain is performed to match a DC offset variation of the main push-pull signal with a DC offset variation of the sub-push-pull signal.

19. The method of claim 15, wherein a bandwidth to filter the noise is lower than an RF signal frequency of the optical information storage medium and is higher than an eccentric frequency of the optical information storage medium.

20. The method of claim 19, wherein the bandwidth to filter the noise is less than 50 Hz.

21. An optical information storage medium system, comprising:
an optical pick-up, comprising:
a diffraction device to divide a light beam into a main light beam and a first diffracted light beam, and
a photo detector to detect the main light beam and the first diffracted light beam; and
a signal operating part to respectively generate a main push-pull signal and a first sub-push-pull signal based on the main light beam and the first diffracted light beam, to electrically filter the first sub-push-pull signal, and to generate a tracking error signal based on the main push-pull signal and the electrically filtered first sub-push-pull signal.

22. The optical information storage medium system of claim 21, wherein the photo-detector comprises:
a main photo detector to detect the main light beam reflected by the optical information storage medium; and
a first sub-photo detector to detect the first diffracted light beam reflected by the optical information storage medium.

23. The optical information storage medium system of claim 21, wherein the signal operating part comprises.
a first operating part and a second operating part to respectively generate the main push-pull signal and the first sub-push-pull signal;
a noise removing unit to electrically filter the first sub-push-pull signal to remove noise caused by part of the light reflected by a layer other than a target layer for recording and/or reproducing data to and/or from the optical information storage medium; and
a subtractor to generate the tracking error signal by subtraction using the main push-pull signal and the first sub-push-pull signal.

24. The optical information storage medium system of claim 23, further comprising a second sub-photo detector to detect a second diffracted light beam reflected by the optical information storage medium, wherein:
the first diffracted light beam comprises a +1st-order diffracted light beam and the second diffracted light beam comprises a −1st-order diffracted light beam, and
the second operating part respectively generates the first sub-push-pull signal and a second sub-push-pull signal from the +1st-order diffracted light beam and the −1st-order diffracted light beam.

25. The optical information storage medium system of claim 23, wherein the noise removing unit comprises a low frequency band-pass filter.

26. A method of generating a tracking error signal, comprising:
generating a main push-pull signal and a first sub-push-pull signal using a main light beam reflected by an optical information storage medium and a first diffracted light beam reflected by the optical information storage medium;
electrically filtering the first sub-push-pull signal; and
generating a tracking error signal based on the main push-pull signal and the first sub-push-pull signal.

27. The method of claim 26, wherein the generating of the main push-pull signal comprises:
adding two detected portions of the main light beam together;
adding another two detected portions of the main light beam together; and
subtracting one of the added results from the other of the added results.

28. The method of claim 26, further comprising generating a second sub-push-pull signal using a second diffracted light beam reflected by the optical information storage medium, wherein the first diffracted light beam comprises a +1st-order diffracted light beam and the second diffracted light beam comprises a −1st-order diffracted light beam.

29. The method of claim 28, further comprising electrically filtering the second sub-push-pull signal, wherein the electrically filtering of the first sub-push-pull signal and the second sub-push-pull signal comprises:
filtering a phase change component caused by track transverse of the +1st-order diffracted light beam from the first sub-push-pull;
filtering a phase change component caused by track transverse of the −1st-order diffracted light from the second sub-push-pull signal;
adding the first sub-push-pull signal and the second sub-push-pull signal;
adjusting a gain of the added sub-push-pull signal; and
filtering the added sub-push-pull signal.

30. The method of claim 29, wherein the adjusting of the gain comprises adjusting a gain to match a DC offset variation of the added sub-push-pull signal with a DC offset variation of the main push-pull signal.

31. The method of claim 26, wherein the generating of the tracking error signal comprises subtracting the first sub-push-pull signal from the main push-pull signal.
